(19) United States
(12) Patent Application Publication
(10) Pub. No.: US 2010/0028699 A1
(43) Pub. Date: Feb. 4, 2010

(54) METAL-CERAMIC COMPOSITE WITH GOOD ADHESION AND METHOD FOR ITS PRODUCTION

(75) Inventors: Reinhard Lenk, Dresden (DE); Tassilo Moritz, Freiberg (DE); Andreas Baumann, Dresden (DE)

Correspondence Address: GREENBLUM & BERNSTEIN, P.L.C., 1950 ROLAND CLARKE PLACE, RESTON, VA, 20191, US

(73) Assignee: FRAUNHOFER-GESELLSCHAFT ZUR FOERDERUNG DER ANGEWANDTEN FORSCHUNG E.V., Muenchen (DE)

(21) Appl. No.: 12/519,092

(22) PCT Filed: Dec. 11, 2007
(86) PCT No.: PCT/EP07/63745

§ 371 Date: Jun. 12, 2009

(30) Foreign Application Priority Data
Dec. 13, 2006 (DE) 10 2006 060 338.9

(51) Int. Cl. B32B 15/04; C04B 37/02; B22F 1/00; B22F 3/10

(52) U.S. Cl. 428/472; 428/469; 428/472.2; 156/89.28; 419/10

(57) ABSTRACT

The invention relates to the field of material sciences and relates to a metal-ceramic composite with good adhesive strength, such as can be used, for example, for forming tools or cutting tools. The object of the present invention lies in the disclosure of a metal-ceramic composite with good adhesive strength which has a strong and durable bond between ceramic and metal. The object is attained with a metal-ceramic composite with good adhesive strength, comprising a metal component and a ceramic component and which are connected to one another by adhesive force or by adhesive force and in a non-positive manner, wherein silicon, beryllium, titanium, chromium, nickel, manganese, hafnium, vanadium, zirconium, aluminum and/or the organic compounds thereof is present in the area of the connection surfaces and wherein the components have been processed as a greenbody to form a composite and jointly sintered. The object is further attained through a method in which at least respectively one metal component and ceramic component are connected as a total greenbody and jointly subjected to a temperature treatment, at least for sintering the ceramic components.

The invention relates to the field of material sciences and relates to a metal-ceramic composite with good adhesive strength, such as can be used, for example, for forming tools, cutting tools or for medical applications as surgical instruments or dental parts, and a method for the production thereof.

Due to its high hardness, its temperature resistance and abrasion resistance as well as its high chemical resistance, zirconium oxide is used for a broad range of applications as a ceramic construction material.

Material composites are produced in order to achieve new types of application possibilities, in order to create new property combinations and in order to compensate for the disadvantages of some materials.

A joining method that ensures a durable and mechanically stable connection of these materials to one another is therefore of great importance.

Compared to mechanical or positive connections, joining techniques by adhesive force provide the advantage of a uniform transfer of force and of a gas-tight and structurally more favorable connection form (Wielage, B.: Technische Keramik, Vulkanverlag, Essen, 1^{st} ed. 1988, p. 158-161).

It is known according to the prior art to produce multiple-component components from ceramic and metal by means of joining technology (active soldering) (Wielage, B.; Ashoff, D.; Aktivlöten von Ingenieurkeramik. Hart- und Hochtemperaturlöten. Vorträge des 9. Dortmunder Hochschulkolloquiums, Dec. 6/7, 1990, Dortmund: Deutscher Verlag für Schweiβtechnik, p. 15-20). Furthermore, in dental technology veneered dental implants can be produced by firing ceramic on metal bodies (Eichner, K.; Kappert, H. F.: Zahnärztliche Werkstoffe und ihre Verarbeitung, Vol. 1 Grundlagen und Verarbeitung, Benetzbarkeit und Verbundbildende Eigenschaften. Georg Thieme Verlag (2000), 356-357).

The multi-component injection molding shaping method originating in the field of plastics processing and suitable for mass production is able to produce in a manner that is close to final contours and in a geometrically variable manner. DE 196 52 223 A1 describes a composite molded article produced by thermoplastic shaping. It comprises at least two ceramic and/or powder metallurgical materials and at least one thermoplastic binder and is characterized in that partial volumes are present inside the molded article, which have different composition in terms of materials and/or have a different content of particles of the material(s) in the thermoplastic or thermosetting binder.

US 2003/0062660 likewise describes the production of molded parts comprising two or more components via multi-component powder injection molding, optionally of ceramic and/or metallic powder materials.

DE 10 2004 006 954 A1 describes a method for the production of a material composite which is composed of at least one component produced by powder injection molding and at least one second component produced with a method different from power injection molding. Thus, for example, the at least two components can be joined to one another here before the debinding or before the sintering, wherein during the subsequent sintering the molded article produced by powder injection molding shrinks onto the molded article produced by a method other than powder injection molding.

Active soldering represents a joining technology by adhesive force. Since ceramic surfaces due to their different bonding conditions (ionic bond and covalent bond) with respect to metallic materials (metal bond) are not wetted by metallic melting, solder alloys are used that contain very reactive elements, such as titanium, zirconium or hafnium. The so-called active solder component causes a surface dissociation of the ceramic with a subsequent chemical reaction between the active metal and the ceramic, which lead to the formation of so-called reaction layers on the solder/ceramic interface. A wetting through the solder base metals is rendered possible via these chemical interactions and thus a soldered composite can be produced. The properties of the reaction layer formed (density, hardness, thermal expansion behavior and modulus of elasticity) decisively influence the properties of the material composite. A metallizing step of the ceramic surface, such as is necessary with two-stage soldering, is omitted. First studies of active soldering were already carried out over 50 years ago. To date this method has been accepted in power electronics, particularly in the production of electron tubes, vacuum switches, junction voltage conductors and thyristor housings, in mechanical engineering and in energy technology, e.g., for soldering ceramic turbocharger rotors on metallic shafts, soldered ceramic cutting materials, ceramic heat exchangers, ceramic microreactors (Moritz, T.; et al.: Int. J. Appl. Ceram. Technol., 6 (2005) 2, 521-528), combustion chamber linings or structures in the field of nuclear fusion installations (Lugscheider, E.; Tillmann, W.; Werkstoffe und Innovationen, 5 (1992) 5/6, 44-48).

The following requirements are made of active solders via which ceramic/ceramic or ceramic/metal composites are to be realized:
good wetting of ceramic and metal by the solder;
achievement of the best possible adhesive strength between the components to be joined;
high ductility of the solder for the reduction of tensions through plastic deformation;
adequate thermal stability and
formation of a reaction layer as thin as possible on the ceramic surface, which permits a wetting, but at the same time prevents harmful chemical interactions of the active metal with the ceramic during use.

Active soldered composites of ZrO₂ (MgO stabilized as well as Y₂O₃ stabilized) to themselves and to steel are known (Krappitz, H.; et al.; Konferenz-Einzelbericht: DVS-Berichte, Vol. 125 (1989), p. 80-85, DVS-Verlag, Düsseldorf).

Due to the linear thermal coefficient of expansion of 10.4·10⁻⁶ K⁻¹, which is relatively high for ceramics, of the construction ceramics zirconium oxide ceramic is the material of choice for a connection to steel (linear coefficient of expansion of steel 430=10.0 . . . 11.5·10⁻⁶ K⁻¹).

The disadvantage with the active soldering process described is that the presence of a high vacuum is necessary and the solder materials, mostly copper-based or copper/silver-based solders, are very expensive. Furthermore, waste is to be expected when applying the solders to the joining surfaces, in particular when round plates or ring surfaces are to be joined. Another problem is the fixing of the two joining partners during the soldering process.

Furthermore, DE 10327708 A1 describes a soldering method for the production of gas-tight and high temperature-resistant connections of molded parts of non-oxide ceramic by means of lasers. A solder comprising yttrium oxide and/or zirconium oxide, aluminum oxide, silicon dioxide and silicon is thereby used, which is melted on the joining surface under laser action and thus leads without a protective atmosphere or vacuum to the connection by adhesive force of two already sintered non-oxide ceramics.

The disadvantage of the methods already listed is to be seen primarily in that only relatively simple flat joining surfaces can be connected to one another, since otherwise the solder would run out during joining.

Metal-ceramic composite systems combine the advantageous properties of the metals (high tensile strength) with those of ceramic (high hardness, chemical resistance, biocompatibility). With the dental technical applications, ceramic masses are fired onto prefabricated metal frames. The degree of wetting achievable during the combustion process between metal and ceramic represents the essential criterion for the achievement of a material composite with good adhesion (Krappitz, H.; et al.: Konferenz-Einzelbericht: DVS-Berichte, Vol. 125 (1989), p. 80-85, DVS-Verlag Düsseldorf). In order to obtain a composite by adhesive force between metal and ceramic, so-called adherence oxide formers (these can be Ni, Cr, Be, Mn, Ti or Si) are used. A temperature treatment in air oxidizes these elements so that the oxides produced on the surface of the framework metal body render possible the chemical bond to the ceramic. Adherence oxide formers, if they are not present in sufficient quantity in the framework metal alloy, are added thereto (Strietzel, R.: Metall-Keramik-Systeme, Physikalische Eigenschaften Part I. Dental Labor, LIII (2005) 5, 847-851). Adherence oxide formers can diffuse during a heat treatment from the interior of the framework metal to the surface thereof and there form an oxide layer (Siebert, G. K., et al.: Deutsche Zahnärztliche Zeitschrift Z (1985) 40, 1163-1168; Walter, M.: Deutsche Zahnärztliche Zeitschrift Z (1989) 44, 248-253). Essential composite-forming properties are ascribed to silicon in particular. It is assumed that due to its high affinity to oxygen this element forms O₂ bridges between the SiO₂ polymer chains and thus contributes to the composite between metal and ceramic.

The bonding strategies with the aid of adherence oxide formers known according to the prior art relate exclusively to dental technical metal-ceramic composites and are specially adapted to dental alloys. The production of corresponding composites is multi-stage in terms of material technology and process engineering and limited to veneered dental implants.

The object of the present invention lies in disclosing a metal-ceramic composite with good adhesion, which has a strong and durable bond regardless of the type, shape and structure of the bond interfaces between ceramic and metal to be joined, and a simple and cost-effective method for the production thereof.

The object is attained through the invention disclosed in the claims. Advantageous embodiments are the subject matter of the subordinate claims.

The metal-ceramic composite with good adhesion according to the invention comprises at least one metal component and at least one ceramic component, wherein both components show a shrinkage that is virtually the same in terms of amount under sintering conditions and are connected to one another at their connection surfaces by adhesive force or by adhesive force and in a non-positive manner, wherein at least one of the components of the composite before and after the production of the composite contains silicon, beryllium, titanium, chromium, nickel, manganese, hafnium, vanadium, zirconium, aluminum and/or the organic compounds thereof in the area of the connection surfaces and wherein the components at least as a greenbody have been processed to form a composite and jointly sintered.

Advantageously, the metal component comprises steel, steel alloys or special-purpose steel.

Likewise advantageously, the ceramic component comprises ZrO₂, Al₂O₃, spinels, aluminum oxide-reinforced zirconium oxide, zirconium oxide-reinforced aluminum oxide, porcelain, hydroxylapatite, tri-calcium phosphate.

Furthermore, it is advantageous if the connection has strengths of at least 1 MPa.

It is also advantageous if silicon, beryllium, titanium, chromium, nickel, manganese, hafnium, vanadium, zirconium, aluminum in the form of pure elements and/or the organic compounds thereof before the formation of the composite oxides, mixed oxides or intermetallic compounds are present in the area of the connection surfaces.

It is also advantageous if silicon, beryllium, titanium, chromium, nickel, manganese, hafnium, vanadium, zirconium, aluminum and/or organic compounds thereof after the formation of the composite in the form of pure elements, oxides, mixed oxides or intermetallic compounds that are formed of elements of the two compounds, are present in the area of the connection surfaces.

It is likewise advantageous if the metal component and the ceramic component are respectively used as powders and have been processed to form a composite greenbody.

It is also advantageous if a greenbody has been produced respectively from the metal component and the ceramic component which then have been joined to form a total greenbody.

Furthermore, it is advantageous if common sintering have been carried out under conditions for the sintering of the ceramic component.

It is also advantageous if a higher concentration of silicon, beryllium, titanium, chromium, nickel, manganese, hafnium, vanadium, zirconium, aluminum and/or the organic compounds thereof in the form of pure elements, oxides, mixed oxides or intermetallic compounds is present in the area of the connection surfaces.

It is also advantageous if the concentration of silicon, beryllium, titanium, chromium, nickel, manganese, hafnium, vanadium, zirconium, aluminum and/or the organic compounds thereof in the form of pure elements, oxides, mixed oxides or intermetallic compounds is higher by at least 5% than the concentration of silicon, beryllium, titanium, chromium, nickel, manganese, hafnium, vanadium, zirconium, aluminum and/or the organic compounds thereof in the form of pure elements, oxides, mixed oxides or intermetallic compounds in the two components.

Furthermore it is advantageous if the area of the connection surfaces comprises the direct surfaces of the two components as well as the area that directly adjoins the surfaces.

It is also advantageous if silicon, beryllium, titanium, chromium, nickel, manganese, hafnium, vanadium, zirconium, aluminum and/or the organic compounds thereof are present in the form of pure elements, oxides, mixed oxides or intermetallic compounds as wetting materials on and between the connected surfaces of the components and at the same time silicon, beryllium, titanium, chromium, nickel, manganese, hafnium, vanadium, zirconium, aluminum and/or the organic compounds thereof in the form of pure elements, oxides, mixed oxides or intermetallic compounds are present in the area of the connection surfaces below the surfaces and/or silicon, beryllium, titanium, chromium, nickel, manganese, hafnium, vanadium, zirconium, aluminum and/or the organic compounds thereof have undergone a chemical connection there with one or more constituents of the metal component and/or ceramic component.

It is likewise advantageous if the composite comprises one or more different metal components and/or ceramic components.

And it is also advantageous if the composite has several connection surfaces embodied to be different in type and shape between the same or different metal components and ceramic components.

It is furthermore advantageous if both components show a shrinkage difference with a difference of ≦1% under sintering conditions.

With the method according to the invention for producing a metal-ceramic composite with good adhesion, at least respectively one metal component and ceramic component are connected as a total greenbody and jointly subjected to a temperature treatment at least for the sintering of the ceramic components.

It is advantageous if the temperature treatment is carried out at temperatures >1000° C.

It is likewise advantageous if the temperature treatment is carried out at temperatures >1300° C.

And it is also advantageous if the metal component and/or the ceramic component are processed as powder to form a respectively individual greenbody or to form a total greenbody.

Furthermore, it is advantageous if individual metal greenbodies and ceramic greenbodies are processed to form a total greenbody.

It is also advantageous if a total greenbody is produced from metal powders and ceramic powders and the temperature treatment is carried out at the same time.

It is likewise advantageous if the temperature treatment is carried out under hydrogen or hydrogenous atmosphere.

And it is also advantageous if the temperature treatment is carried out under vacuum.

The composite according to the invention between the metallic and ceramic materials to be connected is advantageously obtained in that ceramic powder and metal powder are processed to form a pressure granulate, a thermoplastic mass or a suspension. Advantageously, both powdery base materials are processed to form a material composite. This can be carried out for example in that
both pressure granulates are pressed to one another in layers, or
both thermoplastic masses are connected to one another simultaneously or sequentially via multi-component injection molding or already pre-injected single-component parts are sprayed onto the respective other thermoplastic mass, or
films of both materials cast from suspensions are connected to one another via lamination and/or adhesion and/or pressing, or
films cast from suspensions are sprayed with a thermoplastic mass of the other material or
films cast from suspensions are pressed with a granulate of the other material to form a composite body.

Both material components formed to a total greenbody are subjected jointly to a debinding process, wherein the debinding can be carried out thermally, through solvent extraction, through catalytic decomposition or combinations of the cited methods. Subsequently the material composite is subjected to a temperature treatment, which leads at least to the sintering of the ceramic/metal component.

The composite formation is carried out during the temperature increase and during the sintering process of the total greenbody or during the compression and simultaneous increase in temperature of powdery source materials, wherein the metal powder and/or ceramic powder contains >0-10% silicon and/or organic silicon compounds, preferably 0.6% with steel and 0.03% with ZrO₂ (see, e.g., Tables 1 and 2). It must be ensured thereby that at least one of the powders or components contains silicon and/or an organic silicon compound. The silicon and/or the silicon compounds diffuse during the temperature increase/sintering process on the bond interface between metal and ceramic. There the silicon and/or the silicon compounds wet the ceramic and/or metal surface and can also form connections with constituents of the ceramic and or the metal. In the case of zirconium oxide ceramic and steel as composite partners, zirconium silicate can form in the area of the composite surface. A reaction of this type improves the achievement of a composite with good adhesion between the ceramic and metal partners. The presence of silicon or organic silicon compounds can be carried out through a doping in the source materials or also through the addition of organic silicon precursors to the source materials. Moreover, diverse organosilicon compounds can be present as constituents of the powders or also of the binder. Depending on the method, a binder constituent of this type (optionally also a powder constituent) can preferably be locally concentrated in the direct vicinity of the joint zone, such as, for example, a film in which a package identical per se to the powder is realized in the multi-layer method in altered binder composition (with silanes, silazanes).

Achieving innovative strategies for sinter-stable composites with good adhesive strength between ceramic and metal is the focus of current research. The combination of the physical properties (brittle-ductile, insulating-electrically conducting, non-magnetic-magnetic, etc.) of the two dissimilar materials in one component increases the functional density, whereby the required geometric dimensions can be miniaturized.

Due to the high degree of automation, the suitability for mass production, the high dimensional consistency and the component production with close to final contours, multi-component powder injection molding is regarded within the powder technology routes as the method of choice for the technical realization of metal-ceramic composites. The joining step (coshaping) between ceramic and metallic injection molding mass (feedstock) can be carried out in situ through sequential or additive injection into the tool mold. Subsequently the composite injection molding as a total greenbody is subjected to a debinding process and sintering (cofiring) for both joining partners.

The invention is described in more detail below based on several exemplary embodiments:

### EXAMPLE 1

(Steel Feedstock/ZrO₂ Feedstock, Si as Doping Element in the Steel)

TABLE 1
specifications of selected stainless steel powders

| Type | Cr | Cu | Ni | Mn | Si | Nb | Mo | N | O | C | P | S | Fe |
|---|---|---|---|---|---|---|---|---|---|---|---|---|---|
| 430L | 16.9 | — | — | 0.7 | 0.6 | — | — | — | — | 0.02 | 0.03 | 0.007 | Balance |
| 17-4PH | 16.2 | 4.3 | 4.2 | 0.5 | 0.5 | 0.3 | 0.2 | 0.1 | 0.3 | 0.05 | 0.03 | 0.004 | Balance |

Steel feedstock:

Type 17-4PH; fullness 55% by volume

TABLE 2
specification of selected ZrO₂ powder
Type 17-4PH; fullness 55% by volume

| Type | Y5-5 |
|---|---|
| Y₂O₃ | 5.2 |
| Al₂O₃ | 0.34 |
| SiO₂ | 0.03 |
| Fe₂O₃ | 0.02 |
| Na₂O | — |
| TiO₂ | 0.08 |
| ZrO₂ + HfO₂ | Balance |

Ceramic feedstock:

Powder: ZrO₂ (3 mol% Y) type Y5-5

Powder manufacturer: United Ceramics Ltd.

Fullness: 60% by volume

The steel powder 17-4PH used is alloyed with silicon (see Tables 1 and 2). For the production of the feedstock, as a ceramic powder, ZrO₂ type Y5-5 is mixed with S thermoplastic binders with the action of temperature and shearing energy on a shearing roller compactor. The production of the injection molding feedstock is carried out with the steel powder in the same way. The homogenized powder/binder mixture is granulated and in this form fed to the injection molding process. The injection of the steel component and the ceramic component is carried out sequentially on a 2-component injection molding machine. The two injection molding molded articles are placed one above the other and jointly subjected to the debinding process (air atmosphere 400° C.) and jointly sintered (H₂ atmosphere 1450° C.), during which the forming composite molded body is released from the binder phase and densely sintered with identical shrinkage amount to virtually the material densities corresponding to the joining partners.

After the sintering treatment, a thermal shock resistant steel-ceramic composite is obtained that has at least a 4-point bending fracture strength of 1.2 Mpa. With a grinding preparation of the joining zone, a continuously closed (because wetted) composite zone with in part external phase constituents (zirconium silicate) detectable by radiography is discernible under the electron microscope.

### EXAMPLE 2

(Si as Powdery Addition)

To produce the composite, a feedstock filled with steel powder 430 is used. The steel powder used is thereby alloyed with silicon. For the ceramic feedstock production ZrO₂ type Y5-5 is used as a ceramic powder, which was doped with 1% silicon, is mixed with a thermoplastic binder with the action of temperature and shearing energy on a shearing roller compactor. The production of the injection molding feedstock from the steel powder is carried out in the same way. The homogenized powder/binder mixture is granulated and fed in this form to the injection molding process. The injection of the steel component and the ceramic component was carried out sequentially on a 2-component injection-molding machine. The two injection molding molded articles are placed one above the other and subjected jointly to a debinding process (air atmosphere 400° C.) and jointly sintered (H₂ atmosphere 1450° C.), during which the forming composite molded bodies are released from the binder phase and densely sintered with identical shrinkage amount to virtually the material densities corresponding to the joining partners.

After the sintering treatment, a thermal shock resistant steel-ceramic composite is obtained, which has at least a 4-point bending fracture resistance of 1.5 Mpa. With a grinding preparation of the joint zone, a continuously closed (because wetted) composite zone with in part external phase constituents (zirconium silicate) detectable by radiography is discernible under the electron microscope.

1. Metal-ceramic composite with good adhesive strength, comprising at least one metal component and at least one ceramic component, wherein both components show a shrinkage that is virtually the same in terms of amount under sintering conditions and are connected to one another at their connection surfaces by adhesive force or by adhesive force and in a non-positive manner, wherein at least one of the components of the composite before and after the production of the composite contains silicon, beryllium, titanium, chromium, nickel, manganese, hafnium, vanadium, zirconium, aluminum and/or the organic compounds thereof in the area of the connection surfaces and wherein the components at least as a greenbody have been processed to form a composite and jointly sintered.

2. Composite according to claim 1, in which the metal component comprises steel, steel alloys or special-purpose steel.

3. Composite according to claim 1, in which the ceramic component comprises ZrO₂, Al₂O₃, spinels, aluminum oxide-reinforced zirconium oxide, zirconium oxide-reinforced aluminum oxide, porcelain, hydroxylapatite, tri-calcium phosphate.

4. Composite according to claim 1, in which the connection has strengths of at least 1 MPa.

5. Composite according to claim 1, in which silicon, beryllium, titanium, chromium, nickel, manganese, hafnium, vanadium, zirconium, aluminum in the form of pure elements and/or the organic compounds thereof before the formation of the composite oxides, mixed oxides or intermetallic compounds are present in the area of the connection surfaces.

6. Composite according to claim 1, in which silicon, beryllium, titanium, chromium, nickel, manganese, hafnium, vanadium, zirconium, aluminum and/or organic compounds thereof after the formation of the composite in the form of pure elements, oxides, mixed oxides or intermetallic compounds that are formed of elements of the two compounds, are present in the area of the connection surfaces.

7. Composite according to claim 1, in which the metal component and the ceramic component have been respectively used as a powder and processed to form a composite greenbody.

8. Composite according to claim 1 in which a greenbody has been produced respectively from the metal component and the ceramic component, which then have been connected to form a total greenbody.

9. Composite according to claim 1, in which the common sintering is carried out under conditions for the sintering of the ceramic component.

10. Composite according to claim 1, in which a higher concentration of silicon, beryllium, titanium, chromium, nickel, manganese, hafnium, vanadium, zirconium, aluminum and/or the organic compounds thereof in the form of pure elements, oxides, mixed oxides or intermetallic compounds is present in the area of the connection surfaces.

11. Composite according to claim 10, in which the concentration of silicon, beryllium, titanium, chromium, nickel, manganese, hafnium, vanadium, zirconium, aluminum and/or the organic compounds thereof in the form of pure elements, oxides, mixed oxides or intermetallic compounds is higher by at least 5% than the concentration of silicon, beryllium, titanium, chromium, nickel, manganese, hafnium, vanadium, zirconium, aluminum and/or the organic compounds thereof in the form of pure elements, oxides, mixed oxides or intermetallic compounds in the two components.

12. Composite according to claim 1, in which the area of the connection surfaces comprises the direct surfaces of the two components as well as the area that directly adjoins the surfaces.

13. Composite according to claim 1, in which silicon, beryllium, titanium, chromium, nickel, manganese, hafnium, vanadium, zirconium, aluminum and/or the organic compounds thereof in the form of pure elements, oxides, mixed oxides or intermetallic compounds are present as wetting materials on and between the connected surfaces of the components and at the same time silicon, beryllium, titanium, chromium, nickel, manganese, hafnium, vanadium, zirconium, aluminum and/or the organic compounds thereof in the form of pure elements, oxides, mixed oxides or intermetallic compounds are present in the area of the connection surfaces below the surfaces and/or silicon, beryllium, titanium, chromium, nickel, manganese, hafnium, vanadium, zirconium, aluminum and/or the organic compounds thereof have undergone a chemical connection there with one or more constituents of the metal component and/or ceramic component.

14. Composite according to claim 1, in which the composite comprises several different metal components and/or ceramic components.

15. Composite according to claim 1, in which the composite has several connection surfaces embodied to be different in type and shape between the same or different metal components and ceramic components.

16. Composite according to claim 1, in which both components show a shrinkage difference with a difference of ≦1% under sintering conditions.

17. Method for producing a metal-ceramic composite with good adhesion according to claim 1, in which at least respectively one metal component and ceramic component are connected as a total greenbody and jointly subjected to a temperature treatment at least for the sintering of the ceramic components.

18. Method according to claim 17, in which the temperature treatment is carried out at temperatures >1000° C.

19. Method according to claim 18, in which the temperature treatment is carried out at temperatures >1300° C.

20. Method according to claim 17, in which the metal component and/or the ceramic component are processed as a powder to form a respectively individual greenbody or a total greenbody.

21. Method according to claim 20, in which individual metal greenbodies and ceramic greenbodies are processed to form a total greenbody.

22. Method according to claim 17, in which a total greenbody is produced from metal powders and ceramic powders and the temperature treatment is carried out at the same time.

23. Method according to claim 17, in which the temperature treatment is carried out under hydrogen or hydrogenous atmosphere.

24. Method according to claim 17, in which the temperature treatment is carried out under vacuum.
